(19) United States
(12) Patent Application Publication
(10) Pub. No.: US 2008/0243540 A1
(43) Pub. Date: Oct. 2, 2008

(54) Electronic treatment queue

(75) Inventors: Timo Kaukonen, Oulu (FI); Markus Junttila, Oulu (FI)

Correspondence Address: YOUNG & THOMPSON, 209 Madison Street, Suite 500, ALEXANDRIA, VA, 22314, US

(73) Assignee: CORONARIA IMPACT OY, OULU (FI)

(21) Appl. No.: 11/727,980

(22) Filed: Mar. 29, 2007

(51) Int. Cl. G06Q 50/00

(52) U.S. Cl. 705/2

(57) ABSTRACT

Processing of an electronic treatment queue is disclosed. A method for performing this comprises: obtaining electronic data relating to an electronic treatment queue maintained in an electronic data system of a health care provider; creating a patient query to a patient whose temporal position in the treatment queue defined by the electronic data fulfills a predetermined temporal condition; checking whether a patient response made by the patient to the patient query fulfills a predetermined logical condition; and alarming the health care provider that the patient response fulfilled the predetermined logical condition.

### FIELD

The invention relates to processing of an electronic treatment queue.

### BACKGROUND

Traditionally, medical staff has monitored treatment queues. The only way to manage the treatment queue has been by calling up the patients and marking up the changes manually. Such manual work is very labor-intensive and slow; it is only done when absolutely needed due to emerging treatment guarantee demands.

### BRIEF DESCRIPTION

The present invention seeks to provide an improved apparatus, computer program, method and another apparatus.

According to an aspect of the present invention, there is provided an apparatus as specified in claim 1.

According to another aspect of the present invention, there is provided a computer program as specified in claim 11.

According to another aspect of the present invention, there is provided a method as specified in claim 14.

According to another aspect of the present invention, there is provided an apparatus as specified in claim 24.

### LIST OF DRAWINGS

Embodiments of the present invention are described below, by way of example only, with reference to the accompanying drawings, in which FIG. 1 illustrates embodiments of an apparatus;

FIGS. 2, 3, 4 and 5 illustrate various dates relating to a treatment queue; and

FIG. 6 illustrates embodiments of a method.

### DESCRIPTION OF EMBODIMENTS

FIG. 1 illustrates embodiments of an apparatus 114. A service provider may operate and maintain the apparatus 114, but the apparatus 114 may also be more or less integrated with an electronic data system 102 of a health care provider 100. The health care provider 100 may have special staff trained to operate and maintain the apparatus 114, or such service may be outsourced as well.

The electronic data system 102 of the health care provider 100 may be a hospital data system, or any other system suited to maintain patient data 107 and one or more electronic treatment queues 108. For the sake of clarity, only one electronic treatment queue 108 will be described, but the embodiments may be applied to a plurality of electronic treatment queues 108 maintained in the electronic data system 102.

Medical staff 112 of the health care provider 100 may use the electronic data system 102. The user interface 110 of the system 102 may be implemented in prior art ways. Such implementations include, but are not restricted to: desktop computers, laptop computers, workstations, portable digital assistants (PDA), mobile phones, portable touch pads with wireless communication means, or other ways to interface with a data system.

The electronic data system 102 also comprises a processing module 104 configured to process the electronic treatment queue 108 and the patient data 107.

The electronic data system 102 also comprises a data interface 106 configured to exchange electronic data 106 with the apparatus 114. The data interface 106 may be implemented in prior art ways. Such implementations include, but are not limited to: any wired or wireless telecommunications technique and protocol, such as TCP/IP (Transmission Control Protocol/Internet Protocol) connections, cellular radio connections, WLAN (Wireless Local Area Network) connections, or other ways to transfer data to and from the electronic apparatus 114. The exchange of data may be performed on-demand or in a batch run manner.

The apparatus 114 comprises an input interface module 116 configured to obtain electronic data 140, 142 relating to the electronic treatment queue 108 maintained in the electronic data system 102 of the health care provider 100. As illustrated in FIG. 1, the input interface module 116 may be coupled with the data interface 106 of the electronic data system 102.

The apparatus 114 further comprises a processing module 120 configured to create a patient query 144 to a patient 134 whose temporal position in the treatment queue 108 defined by the electronic data 140, obtained from the electronic data system 102, fulfills a predetermined temporal condition.

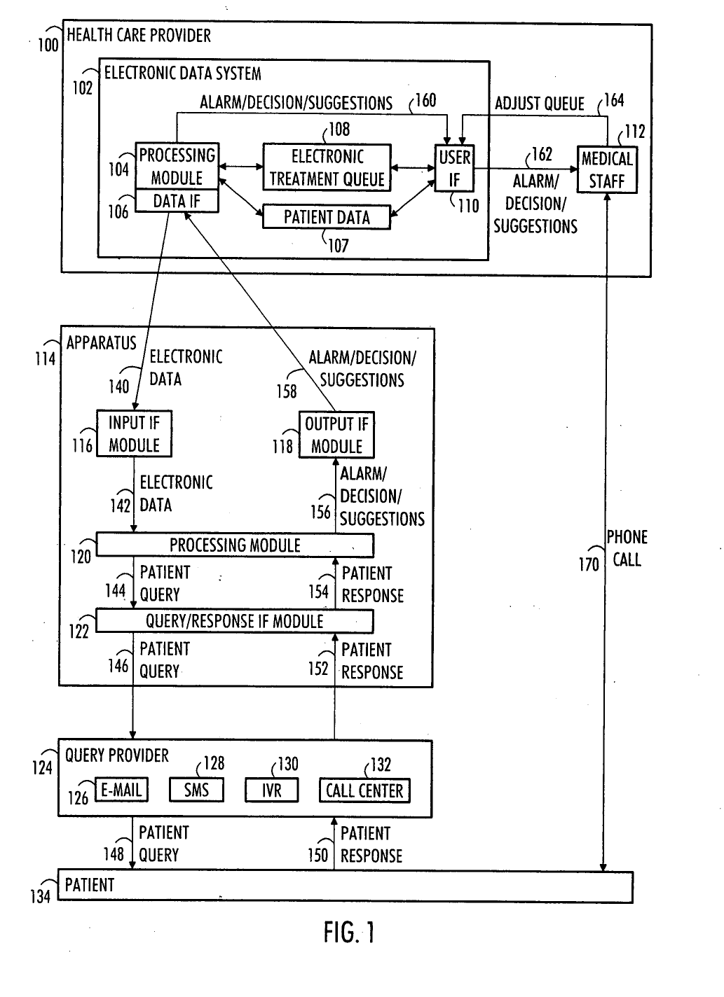

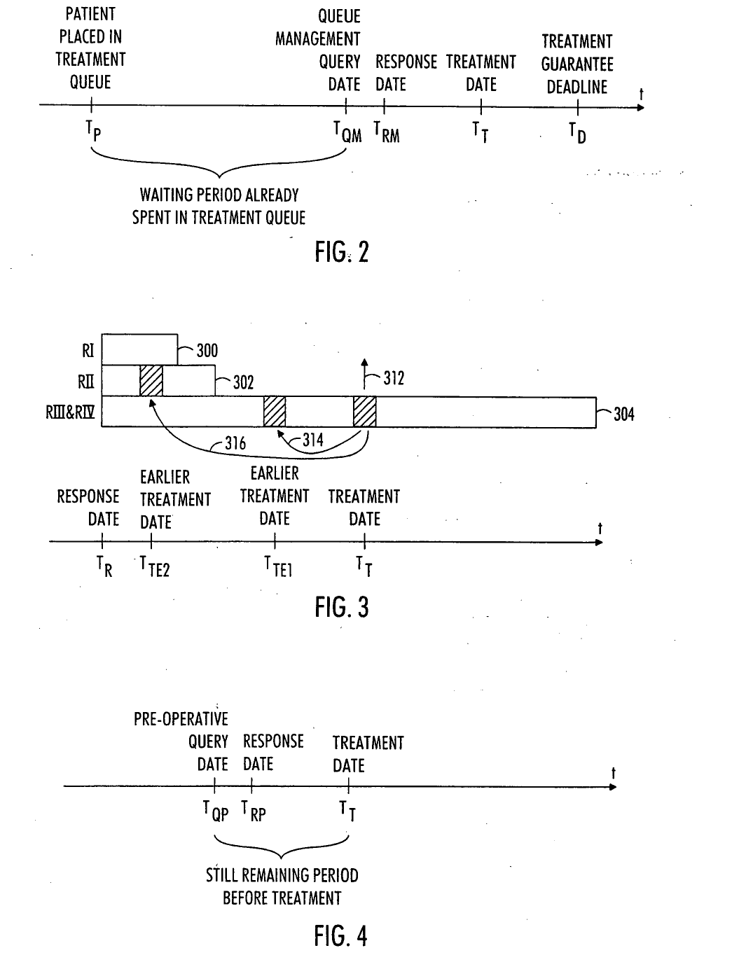

FIGS. 2 and 4 illustrate the meaning of the temporal position and the predetermined temporal condition. The electronic treatment queue 108 may be processed either in order to manage the queue or in order to perform a preoperative query. FIG. 2 illustrates the queue management query, whereas FIG. 4 illustrates the preoperative query. The x-axis illustrates time in both FIGS. 2 and 4.

Let us suppose that the patient 134 is placed in the treatment queue 108 at time T_{P}. At time T_{QM}, it is checked whether the predetermined temporal condition is fulfilled. In FIG. 2, the predetermined temporal condition is a waiting period of a predetermined minimum length already spent in the treatment queue 108, i.e. it is tested whether the patient 134 has already spent a certain minimum amount of time in the treatment queue 108. The waiting period already spent in the treatment queue 108 may then be calculated by subtracting T_{P} from T_{QM}. In the example of FIG. 2, it is further supposed that the predetermined temporal condition is fulfilled, so the patient query 144 is also performed at time T_{QM}. The patient response 154 is received at time T_{RM}. The treatment is agreed to take place at time T_{T}, which is well before a treatment guarantee deadline T_{D}.

In FIG. 4, the predetermined temporal condition is a still remaining period of a predetermined length before the treatment of the patient 134 by the health care provider 100, i.e. it is tested whether the still remaining time before the treatment is short enough. The still remaining period before the treatment may be calculated by subtracting the preoperative query date T_{QP} from the treatment date T_{T}. In the example of FIG. 4, it is further supposed that the predetermined temporal condition is fulfilled, so the patient query 144 is also performed at time T_{QP}. The patient response 154 is received at time T_{RP}.

The predetermined temporal conditions may vary, according to the national standards and requirements relating to the operation of the health care providers, for example. In Finland, the treatment guarantee deadline is six months, i.e. in normal cases the patient will be operated within six months after being placed in the treatment queue 108. The inventors have found out that the suitable time to perform the queue management query is after the patient has been in the treatment queue 108 for four months, i.e. T_{QM}=T_{P}+4 months. The inventors have also found out that the suitable time to perform the preoperative query is two days before the treatment, i.e. T_{QP}=T_{T}−2 days.

The patient query 144, once created, may be performed by prior art ways. The apparatus 114 may further comprise a query/response interface module 122, via which the patient query 146, and a patient response 152, are transferred as at least one of electronic mails, text messages of a radio system, interactive voice response data, and/or call center data.

A query provider 124 may process the patient query 148 and the patient response 150, especially if interactive voice response or call center is used for the implementation.

Interactive voice response IVR 130 is a technology automating interaction with the patient 134. Pre-recorded voice prompts and menus may be used for the patient queries 148, and touch-tone telephone keypad entry (such as Dual-Tone Multi-Frequency DTMF) may be used to gather the patient responses 150. Also voice recognition may be used to gather the spoken words of the patient 134 as the patient response 150. IVR may be implemented over standard telephone lines, or over cellular radio network connections, for example.

A call center 132 may handle inbound/outbound communications with the patients, using manual labor. Such a solution may be suitable, if the call-center is outsourced, i.e. the scale of operation and/or cheap labor makes it financially viable.

An electronic mail system 126 and/or a text message service 128 may also be used to implement the interaction with the patient. The text message service may be a short message service SMS or a multimedia message service MMS, for example. Any other suitable standard/non-standard wireless or wired communication means capable of implementing textual communication may be used as well. The patient 134 may need to access a computer, a mobile terminal operating according to the GSM (Global System for Mobile Communications), WCDMA (Wideband Code Division Multiple Access), WLAN (Wireless Local Area Network) or other wireless communication standard, in order to be able to respond to the patient query 148, but in some cases even a normal telephone will do.

It is to be noted that the patient query 144 and the patient response 154 need not both be performed in a similar manner, i.e. the patient query 144 may be in the form of a text message, but the patient reply 154 may be in the form of an electronic mail message, for example.

The processing module 120 is further configured to check whether the patient response 154 made by the patient 134 to the patient query 144 fulfills a predetermined logical condition.

The apparatus 114 further comprises an output interface module 118 configured to alarm 156, 158 the health care provider 100 that the patient response 154 fulfilled the predetermined logical condition.

The predetermined logical condition may refer to a systematic way to interpret the contents of the patient response 154.

The patient query 144 may comprise questions relating to the current need for treatment of the patient 134 by the health care provider 100, i.e. the patient query 144 then deals with queue management as explained earlier. Such questions with the possible answers may include the following:
A) Question: Has your medical condition improved, declined or remained the same? Answer: Improved/Declined/Remained the same/No answer;
B) Question: Do you still want the treatment? Answer: Yes/No/No answer;
C) Question: Have you been treated elsewhere? Answer: Yes/No/No answer.

The predetermined logical condition may be as follows: If the answer to question A is “Declined”, the alarm is set on in order to move the treatment date to an earlier date. If the answer to question B is “No”, the alarm is set on in order to check the need for the treatment, and then possibly to cancel the treatment. If the answer to question C is “Yes”, the alarm is set on in order to cancel the treatment.

Some of the possible answer combinations, with the possible actions, are then:

A=Remained the same, B=Yes, C=No→No action;

A=Declined, B=Yes, C=No→Set alarm, move the treatment to an earlier date;

A=Improved, B=No, C=No→Set alarm, check the need for the treatment;

A=No answer, B=No, C=Yes→Set alarm, check the need for the treatment;

A=No answer, B=No answer, C=No answer→Set alarm/No action, depending on the defined service level/resource availability.

The patient query 144 may alternatively comprise questions relating to possible obstacles preventing treatment of the patient 134 by the health care provider 100, i.e. the patient query 144 is then actually a preoperative query as explained earlier. Such questions with the possible answers may include the following:
D) Question: Can you come to the operation? Answer: Yes/No/I do not know/No answer.

The predetermined logical condition may be as follows: If the answer to question D is “Yes”, no action is needed. If the answer to question D is “No”, the alarm is set on in order to cancel the treatment. If the answer to question D is “I do not know”, the alarm is set on in order to contact the patient 134 again. If the patient does not answer, the alarm is set on in order to contact the patient 134 again.

There may be also other questions with which it is possible to find out whether the patient 134 may be treated at all. If the patient 134 has not stopped taking medication as instructed, the treatment may not be given, for example. Infection of the patient 134 may also hinder the treatment, for example.

In Finland, a computer system may not independently make a medical decision. It follows that the output interface module 118 may further be configured to inform 158 the health care provider 100 of that the patient response 154 necessitates a medical decision made by the health care provider 100.

Considering that the law and practice may change, and other jurisdictions may have other principles, the processing module 120 may further be configured to make a decision based on the patient response 154, and the output interface module 118 may further be configured to inform 158 the health care provider 100 of the made decision. Referring to earlier example questions and answers, the decision may be one of the following, for example: move the treatment to an earlier date; cancel the treatment; or contact the patient again.

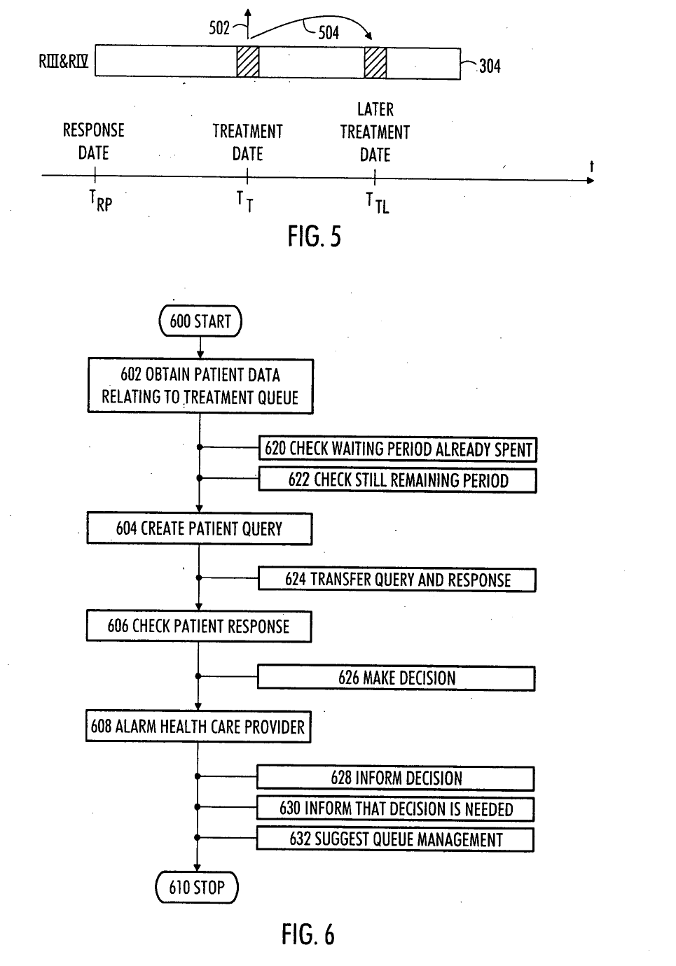

Even if the law prohibits the apparatus 114 to make a medical decision, suggestions may be allowed. FIGS. 3 and 5 illustrate some examples of suggestions.

In FIG. 3, the processing module 120 may further be configured to suggest that on the basis of the patient response (to the queue management query) the patient 134 should either be removed 312 from the treatment queue 304, the patient 134 should be advanced 314, 316 in the treatment queue, or the patient's 134 position in the treatment queue should remain unchanged. FIG. 3 also illustrates that the electronic treatment queue 108 may be hierarchical. In the example of FIG. 3, there are three treatment queues 300, 302, 304. In Finland, for example, there are four different categories for treatment queues (in descending order of urgency): RI=immediately (a treatment queue for operating limbs that came loose, for example), RII=in a few days (a cancer treatment, a balloon angioplasty, for example), RIII and RIV=no immediate threat for life. The treatment date T_{T} may then be advanced to the date T_{TE1} or T_{TE2}, depending on whether the category of the queue needs to be changed as well.

In FIG. 5, the processing module 120 may further be configured to suggest that on the basis of the patient response (to the preoperative query) the patient 134 should either be removed 502 from the treatment queue 304, the patient 134 should be suggested 504 a later date T_{TL} in the treatment queue 304, or the patient's 134 position in the treatment queue 304 should remain unchanged.

Alarms, decisions, suggestions and other possible information may be transferred 156, 158 from the output interface module 118 of the apparatus 114 to the electronic data system 102 of the health care provider 100. The processing module 104 may process the received information 158 and transfer 160 it to the user interface 110 displaying 162 the information to the medical staff 112. The medical staff 112 may then adjust 164 the treatment queue 108 on the basis of the received alarms, decisions, suggestions and other possible information. Hence, if needed, the medical decisions remain in the hands of the medical staff 112. The apparatus 114 kind of filters a vast amount of information regarding the status of the patients in the electronic treatment queue(s) 108. If needed, the medical staff 112 may directly contact the patient 134 through a normal phone call 170. Such phone calls 170 may be needed, but the number of them is reduced to a minimum through the use of the described patient queries 144 and patient responses 154. If the result of the query process is that the patient's 134 position in the treatment queue 108 remains unchanged, the medical staff 112 is not bothered, i.e. the described functionality only uses human resources when needed.

The apparatus 114 may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a carrier and comprising program instructions which, when loaded into a computer, constitute the input interface module 116, the processing module 120, and the output interface module 118 described earlier.

The computer program may be in source code form, object code form, or in some intermediate form, and it may be stored in some sort of carrier, which may be any entity or device capable of carrying the program. Such carriers include a distribution medium, record medium, computer memory, read-only memory, electrical carrier signal, telecommunications signal, and software distribution package, for example. Depending on the processing power needed, the computer program may be executed in a single electronic digital computer or it may be distributed amongst a number of computers.

As was explained earlier, the apparatus 114 may be more or less integrated with the electronic data system 102. The electronic data system 102 may be implemented in a similar fashion as the apparatus 114. Therefore, the computer program (of the apparatus 114) may also partly or wholly run in the electronic data system 102.

Next, a method will be described with reference to FIG. 6. The method relates to processing of an electronic treatment queue. The method starts in 600.

In 602, electronic data relating to an electronic treatment queue maintained in an electronic data system of a health care provider is obtained.

In 604, a patient query is created to a patient whose temporal position in the treatment queue defined by the electronic data fulfills a predetermined temporal condition.

In 606, it is checked whether a patient response made by the patient to the patient query fulfills a predetermined logical condition. If it did, the health care provider is alarmed that the patient response fulfilled the predetermined logical condition in 608. The method ends in 610.

The embodiments of the apparatus 114, described earlier, may be applied to the method as well, changing such things that need to be changed.

In 630, the health care provider may be informed of that the patient response necessitates a medical decision made by the health care provider. Alternatively, a decision may be made based on the patient response in 626, and the health care provider may be informed of the made decision in 628.

In 624, the patient query and the patient response may be transferred as at least one of electronic mails, text messages of a radio system, interactive voice response data, call center data.

In 620, the predetermined temporal condition comprises a waiting period of a predetermined minimum length already spent in the treatment queue, which is checked. Alternatively, the predetermined temporal condition comprises a still remaining period of a predetermined length before the treatment of the patient by the health care provider, which is checked in 622.

Queue management is suggested in 632: it is either suggested that on the basis of the patient response the patient should either be removed from the treatment queue, the patient should be advanced in the treatment queue, or the patient's position in the treatment queue should remain unchanged, or it is suggested that on the basis of the patient response the patient should either be removed from the treatment queue, the patient should be suggested a later position in the treatment queue, or the patient's position in the treatment queue should remain unchanged.

Even though the invention has been described above with reference to an example according to the accompanying drawings, it is clear that the invention is not restricted thereto but can be modified in several ways within the scope of the appended claims.

1. An apparatus comprising:
an input interface module configured to obtain electronic data relating to an electronic treatment queue maintained in an electronic data system of a health care provider;
a processing module configured to create a patient query to a patient whose temporal position in the treatment queue defined by the electronic data fulfills a predetermined temporal condition, and to check whether a patient response made by the patient to the patient query fulfills a predetermined logical condition; and
an output interface module configured to alarm the health care provider that the patient response fulfilled the predetermined logical condition.

2. The apparatus of claim 1, wherein the output interface module is further configured to inform the health care provider of that the patient response necessitates a medical decision made by the health care provider.

3. The apparatus of claim 1, wherein the processing module is further configured to make a decision based on the patient response, and the output interface module is further configured to inform the health care provider of the made decision.

4. The apparatus of claim 1, wherein the apparatus further comprises a query/response interface module, via which the patient query and the patient response are transferred as at least one of electronic mails, text messages of a radio system, interactive voice response data, call center data.

5. The apparatus of claim 1, wherein the predetermined temporal condition comprises a waiting period of a predetermined minimum length already spent in the treatment queue.

6. The apparatus of claim 5, wherein the patient query comprises questions relating to the current need for treatment of the patient by the health care provider.

7. The apparatus of claim 5, wherein the processing module is further configured to suggest that on the basis of the patient response the patient should either be removed from the treatment queue, the patient should be advanced in the treatment queue, or the patient's position in the treatment queue should remain unchanged.

8. The apparatus of claim 1, wherein the predetermined temporal condition comprises a still remaining period of a predetermined length before the treatment of the patient by the health care provider.

9. The apparatus of claim 8, wherein the patient query comprises questions relating to possible obstacles preventing treatment of the patient by the health care provider.

10. The apparatus of claim 8, wherein the processing module is further configured to suggest that on the basis of the patient response the patient should either be removed from the treatment queue, the patient should be suggested a later position in the treatment queue, or the patient's position in the treatment queue should remain unchanged.

11. A computer program embodied on a carrier and comprising program instructions which, when loaded into a computer, constitute the following:
an input interface module configured to obtain electronic data relating to an electronic treatment queue maintained in an electronic data system of a health care provider;
a processing module configured to create a patient query to a patient whose temporal position in the treatment queue defined by the electronic data fulfills a predetermined temporal condition, and to check whether a patient response made by the patient to the patient query fulfills a predetermined logical condition; and
an output interface module configured to alarm the health care provider that the patient response fulfilled the predetermined logical condition

12. The computer program of claim 11, wherein the predetermined temporal condition comprises a waiting period of a predetermined minimum length already spent in the treatment queue.

13. The computer program of claim 11, wherein the predetermined temporal condition comprises a still remaining period of a predetermined length before the treatment of the patient by the health care provider.

14. A method comprising:
obtaining electronic data relating to an electronic treatment queue maintained in an electronic data system of a health care provider;
creating a patient query to a patient whose temporal position in the treatment queue defined by the electronic data fulfills a predetermined temporal condition;
checking whether a patient response made by the patient to the patient query fulfills a predetermined logical condition; and
alarming the health care provider that the patient response fulfilled the predetermined logical condition.

15. The method of claim 14, further comprising: informing the health care provider of that the patient response necessitates a medical decision made by the health care provider.

16. The method of claim 14, further comprising: making a decision based on the patient response; and informing the health care provider of the made decision.

17. The method of claim 14, further comprising: transferring the patient query and the patient response as at least one of electronic mails, text messages of a radio system, interactive voice response data, call center data.

18. The method of claim 14, wherein the predetermined temporal condition comprises a waiting period of a predetermined minimum length already spent in the treatment queue.

19. The method of claim 18, wherein the patient query comprises questions relating to the current need for treatment of the patient by the health care provider.

20. The method of claim 18, further comprising: suggesting that on the basis of the patient response the patient should either be removed from the treatment queue, the patient should be advanced in the treatment queue, or the patient's position in the treatment queue should remain unchanged.

21. The method of claim 14, wherein the predetermined temporal condition comprises a still remaining period of a predetermined length before the treatment of the patient by the health care provider.

22. The method of claim 21, wherein the patient query comprises questions relating to possible obstacles preventing treatment of the patient by the health care provider.

23. The method of claim 21, further comprising: suggesting that on the basis of the patient response the patient should either be removed from the treatment queue, the patient should be suggested a later position in the treatment queue, or the patient's position in the treatment queue should remain unchanged.

24. An apparatus comprising:
means for obtaining electronic data relating to an electronic treatment queue maintained in an electronic data system of a health care provider;
means for creating a patient query to a patient whose temporal position in the treatment queue defined by the electronic data fulfills a predetermined temporal condition;
means for checking whether a patient response made by the patient to the patient query fulfills a predetermined logical condition; and
means for alarming the health care provider that the patient response fulfilled the predetermined logical condition.

25. The apparatus of claim 24, wherein the predetermined temporal condition comprises a waiting period of a predetermined minimum length already spent in the treatment queue.

26. The apparatus of claim 24, wherein the predetermined temporal condition comprises a still remaining period of a predetermined length before the treatment of the patient by the health care provider.
